(19) United States
(12) Patent Application Publication
(10) Pub. No.: US 2005/0258243 A1
(43) Pub. Date: Nov. 24, 2005

(54) Express card interface adapter for small storage media

(76) Inventor: Hsiang-An Hsieh, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/777,733

(22) Filed: Feb. 12, 2004

(30) Foreign Application Priority Data
Nov. 14, 2003 (TW) 092220163

(51) Int. Cl. G06K 7/06; G06K 7/00

(52) U.S. Cl. 235/441; 235/486

(57) ABSTRACT

An Express Card interface adapter comprises a double-configuration connector interface connected to the system end, a CF-standard interface connected to the storage medium being placed in the adapter, and a signal converter control chip connected between the double-configuration connector interface and the CF-standard interface, wherein the signal converter control chip is configured to control signal conversion and signal transmission between the system end and the storage medium.

### BACKGROUND OF THE INVENTION

1. Field of the Invention

The invention relates to an adapter device for small storage media, and more particularly to an Express Card interface adapter for small storage media.

2. Description of the Related Art

As semiconductor manufacturing techniques progress, a type of storage media has been recently developed, commonly called “flash memory cards” (also designated “memory card” hereafter). Compared to the traditional flexible magnetic disk or optical disk, the recently developed memory card has many advantages such as portability, lower power-consumption, fast data transmission, multi-write/readable, anti-vibration functionality, and anti-moisture, etc. Therefore, the flash memory card has been developed into a wide panel of memory card formats adapted for the use in different types of digital appliance, including PCMCIA ATA Flash Card, Compact Flash (CF) Cards, Smart Media (SM) Cards, Multi-Media Cards (MMC), Memory Stick (MS) Cards, Secure Digital (SD) Cards.

With respect to known appliances such as the portable computer or the personal digital assistant (PDA), the PCMCIA interface has become the standard interface for memory cards: a commercially available notebook computer usually has at least one or even more PCMCIA slots. According to the PCMCIA interface standard, computer industries have also developed adapters commonly compatible with a multitude of small memory cards, or adapters provided with additional functions such as Internet connection, telecommunication connection, etc, so that the PCMCIA interface is not used only for the purpose of memory storage. In particular, PCMCIA interface adapters configured to accommodate many memory cards occupy a substantial part of PCMCIA card adapters market.

However, as computer systems operate increasingly faster, modifications are needed to increase the interface bandwidth, its convenience in use and to reduce the system cost. In the year of 2003, the PCMCIA association therefore has launched a new standard of a small storage medium, called “Express Card”. The Express Card standard implements USB 2.0 (480 Mbps) and PCI-Express (2.5 GMbps) as the system connect interface. It can be expected that this double-interface card compatible with high data transmission and having hot plug characteristics will become a future trend of development in the field of PCMCIA cards.

Therefore, there is a present need for a new standard adapter that can associate the use of the Express Card format with presently existed small memory cards and storage media, so that the cost of redesign of specific interfaces for each small storage medium can be avoided.

### SUMMARY OF THE INVENTION

It is therefore an object of the invention to provide an Express Card interface adapter, configured to accommodate storage media of Compact Flash card (CF), MS, SD/MMC, SM, xD with a system end.

In one embodiment, the Express Card interface adapter comprises a casing, a double-configuration connector interface, a reversed U-shape slot and a circuit board. The double-configuration connector interface is mounted at a front of the casing to insert in and connect to a system end. The reversed U-shape slot has a CF-standard interface and formed at a rear end of the adapter by guide tracks that are located at sides of the CF-standard interface. The circuit board is arranged between the double-configuration connector interface and the CF-standard interface. A signal converter control chip connected between the double-configuration connector interface and the CF-standard interface, wherein the signal converter control chip is configured to control signal conversion and signal transmission between the system end and the storage medium.

The CF-standard interface includes at least one CF card detect pin. The double-configuration connector interface includes a card insertion detect pin to detect the insertion of any CF-standard storage media. The system end provides a work voltage according to an enable signal transmitted from the double-configuration connector interface to allow the adapter transmitting different types of electronic signal for controlling the data reading/writing operation.

In another embodiment, the double-configuration connector interface comprises a PCI Express interface and a USB interface. The signal converter control chip is an IDE converter control chip configured to convert storage medium-compatible USB signals to system-compatible IDE signals. The slot also accommodates various types of small memory cards. The double-configuration connector interface includes a plurality of card insertion detect pins to detect the insertion of various types of the memory cards. A signal converter is mounted in the casing to correspond to the slot for signal transmission between the double-configuration connector interface and the system end when the small memory cards insert through the slot.

According to other variation embodiments, the storage media includes small memory cards such as MS, SD/MMC, SM, or xD.

It will be understood that the foregoing summary encompasses some of the many features of the invention, and does not constitute an exhaustive description of all the aspects of the invention. Therefore, the summary of the invention should not be construed in a way to limit the scope of the invention as descried in the claims. To provide a further understanding of the invention, the following detailed description illustrates embodiments and examples of the invention.

### BRIEF DESCRIPTION OF THE DRAWINGS

FIG. 1 is an exploded view of an Express Card interface adapter compatible with small storage media;

FIG. 2 is a perspective view of the assembled adapter of FIG. 1;

FIG. 3 is another perspective view of the assembled adapter of FIG. 1 according to an embodiment of the invention;

FIG. 4 is a diagram of a pin connection scheme implemented for the circuit of the adapter of FIG. 1 according to an embodiment of the invention;

FIG. 5 is an exploded view of an Express Card interface adapter compatible with small storage media according to another variant embodiment of the invention;

FIG. 6 is a perspective view of the assembled adapter of FIG. 5;

FIG. 7 is diagram of a pin connection scheme implemented for the circuit of the adapter of FIG. 5 according to an embodiment of the invention; and

FIG. 8 is a circuit diagram of the connection scheme implemented in the adapter for detecting multi-card insertion according to an embodiment of the invention.

### DETAILED DESCRIPTION OF THE EMBODIMENTS

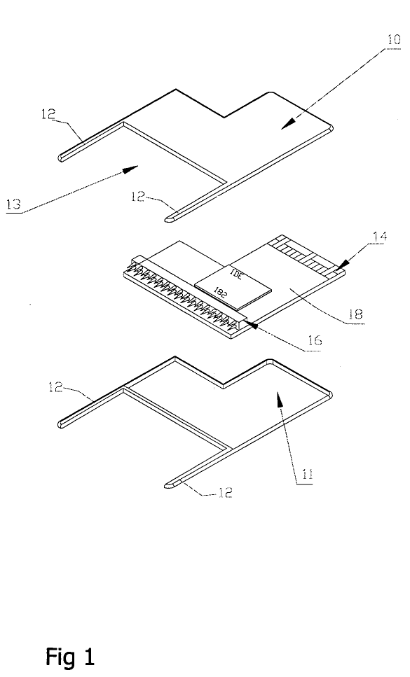

Referring to FIG. 1, the implementation of an Express Card interface adapter is exemplary mounted in a casing structure. The casing structure includes the assembly of first and second case bodies 10, 11.

In the illustrated embodiment, the Express Card interface adapter is exemplary suitable for the specification of Compact Flash (“CF”) Card. The Express Card interface adapter includes an assembly of first and second case bodies 10, 11, a double-configuration connector interface 14, a CF-standard interface 16, a circuit board 18, and IDE converter control chip 182 connected on the circuit board 18.

The double-configuration connector interface 14 is coupled with a system end at a front of the case bodies 10, 11. A rear of the case bodies 10, 11 respectively forms a reversed U-shape 13 with side guide tracks 12, at a side of which is placed the CF-standard interface 16. The CF-standard interface 16 is mounted at an end of the guide tracks 12 adjacent to the double-configuration connector interface 14. A CF storage medium is inserted along the guide tracks 12 to connect to the CF-standard interface 16.

The double-configuration connector interface 14 and the CF-standard interface 16 are connected each other via a circuitry carried by the circuit board 18. The circuit board 18 includes the connection of the IDE converter control chip 182 compatible with CF format devices. The chip 182 is operable to convert IDE standard signals to USB standard signals between an external system terminal and the CF format storage medium. A CF card is compatible with three operating modes, i.e. a memory mode, I/O mode, and a true IDE mode. In the illustrated embodiment, the CF storage medium is used as an external hard disk vis-à-vis the system end. The CF format storage medium in this embodiment therefore has pins that correspond to the true IDE mode of the IDE interface, being implemented as control interface for signal transmission.

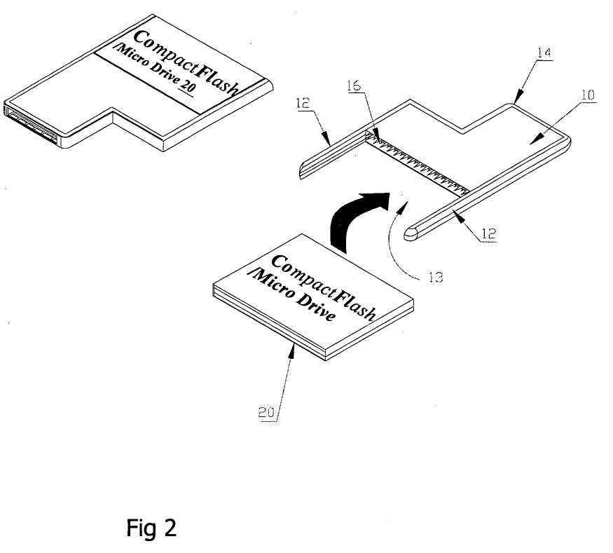

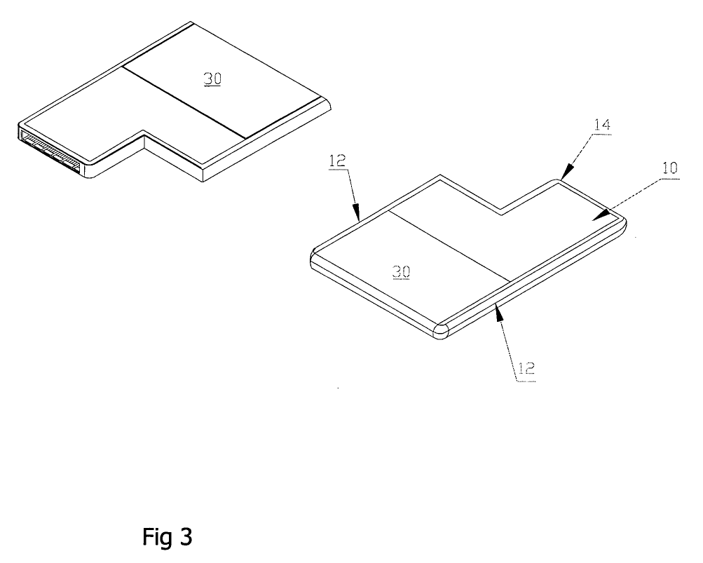

As shown in FIG. 2, the CF-standard storage medium can be a removable CF memory card or a micro-drive 20. As shown in FIG. 3, the CF-standard storage medium can alternatively be a fixed small hard disk 30.

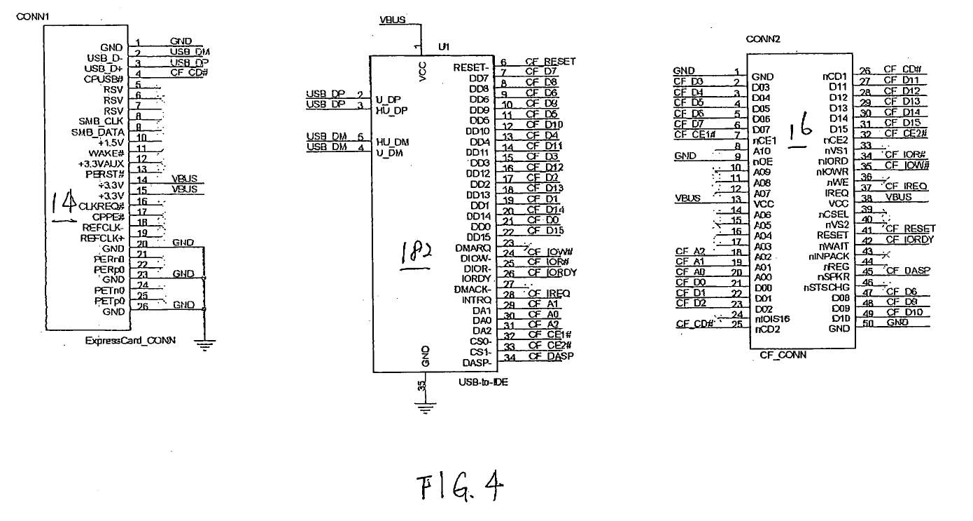

In the embodiment of FIG. 4, the double-configuration connector interface 14 is specifically compatible with Express Cards, the CF-standard interface 16 is specifically compatible with CF storage media, and the IDE converter control chip 182 operates as a signal control core.

The double-configuration connector interface 14 includes two signal transmission formats, which can be a PCI Express interface and a USB interface. According to the design requirement, either the PCI Express interface or the USB interface can be implemented as an operating interface. In the illustrated embodiment, the double-configuration connector interface 14 exemplary operates as a USB interface.

The CF-standard interface 16 includes a CF card detect pins 25 (nCD2), 26 (nCD1). The double-configuration connector interface 14 includes a card insertion detect pin 4 (CPUSB# which is belonged to USB interface, wherein “#” means a “Low-Active” pin) connected to the CF card detect pins 25, 26 for detecting the insertion of a CF format storage medium. The pins 25, 26, 4 are Low-Active pins, i.e. they are at low potential when a CF-standard storage medium is connected, and the card insertion detect pin 4 (CPUSB#) provides a card insertion-enable signal to the system end. The double-configuration connector interface 14 also includes power terminals 14, 15. When the card insertion detect pin 4 (CPUSB#) is in an enabled status, the system end transmits an operating voltage to the adapter so that its internal electronic components can start data reading required for the system.

In an embodiment where the USB interface is implemented for data reading, the IDE converter control chip 182 has two sets of system data transmission pins, i.e. (HU_DP(3), HU_DM(5)) and (U_DP(2), U_DM(4)) pins respectively needed for high-speed USB (transmission rate of about 480 Mbps) and full-speed USB (transmission rate of about 12 Mbps). The double-configuration connector interface 14 has a set of differential serial pins 2, 3 connected to the system data transmission pins. In particular, the pin USB_D− is connected to HU_DM(5) and U_DM(4), and the pin USB_D+ is connected to HU_DP(3) and U_DP(2). Via the foregoing connection scheme, transmission operations can be performed, including address transmission, data transmission, and control signal transmission.

Within the Express Card interface adapter, signal transmission is performed in parallel. The CF-standard interface 16 includes address pins (A00˜A02), data transmission pins (D00˜D15), and control pins (RESET, nIOWR, nIORD, nWAIT, IREQ, nCE1, nCE2, nSPKR). The IDE converter control chip 182 includes address pins (DA0˜DA2), data transmission pins DD0˜DD15), and control pins (RESET−, DIOW−, DIOR−, IORDY, INTRQ, CS0−, CS1−, DASP−).

With the foregoing design, the Express Card interface module can be implemented as a signal converter for CF format storage media. Presently, popular small storage media include xD, SM, SD, MMC and MS series small memory cards. The following description exemplary implements an Express Card interface module as a multi-card adapter compatible with the aforementioned memory cards.

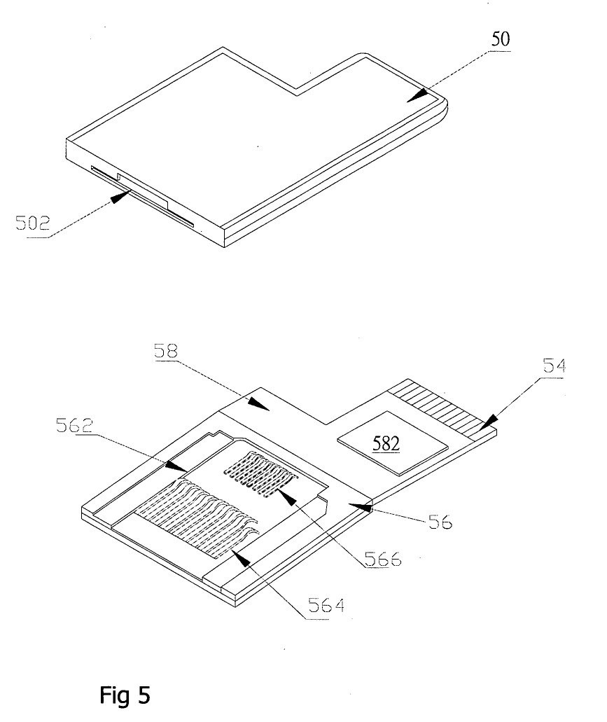

FIG. 5 is a schematic view of an Express Card interface adapter compatible with a plurality of memory cards according to an embodiment of the invention. The Express Card interface adapter includes the assembly of a casing 50, a double-configuration connector interface 54, a signal aconverter 56, a circuit board 58 and a multi-card reader control chip 582 connected on the circuit board 58.

The double-configuration connector interface 54 is assembled at a front of the casing 50, while a slot 502 is formed at a rear of the casing 50 for insertion of small memory cards. The signal converter 56 is placed inside the casing 50 at a location corresponding to the area of the slot 502. The signal converter 56 can receive the placement of a small memory card through which signal transmission is performed via the double-configuration connector interface 54 with the system end. The signal converter 56 can be divided into three structural parts, which include an upper layer for configuring SM/xD contact pins (not shown), an accommodating space 562 for receiving the placement of the memory card, and a lower layer for configuring MS type memory card contact pins 566 and SD/MMC memory card contact pins 564. SM/xD contact pins and MS and SD/MMC contact pins 566, 564 can be interchangeably placed on the upper and lower layers. If there is a sufficient space, all the connection contact pins can be also placed on a same level to obtain a thinner signal converter 56.

The multi-card reader control chip 582 and the circuit board 58 are connected between the double-configuration connector interface 54 and the signal converter 56. The circuit board 58 and the multi-card reader control chip 582 operate as a signal controller between an outer system and the small memory card.

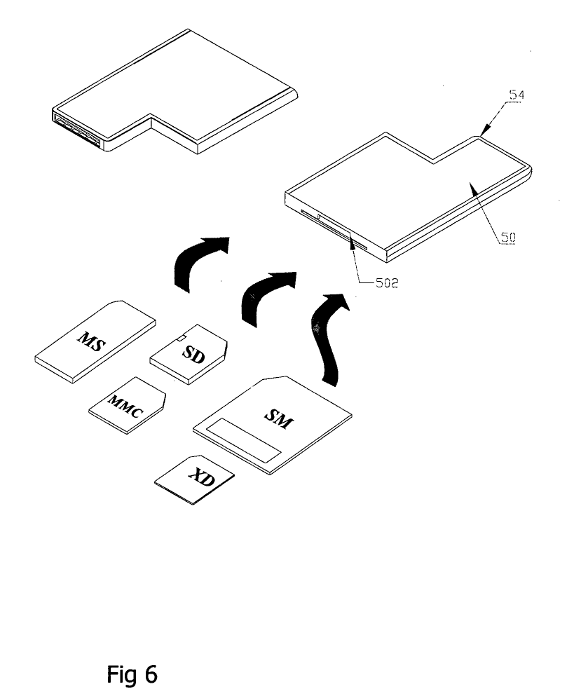

FIG. 6 illustrates the assembled structure of the adapter with an external aspect of an Express Card structure design. The memory cards are inserted in the adapter via the slot 502 at the rear of the casing 50.

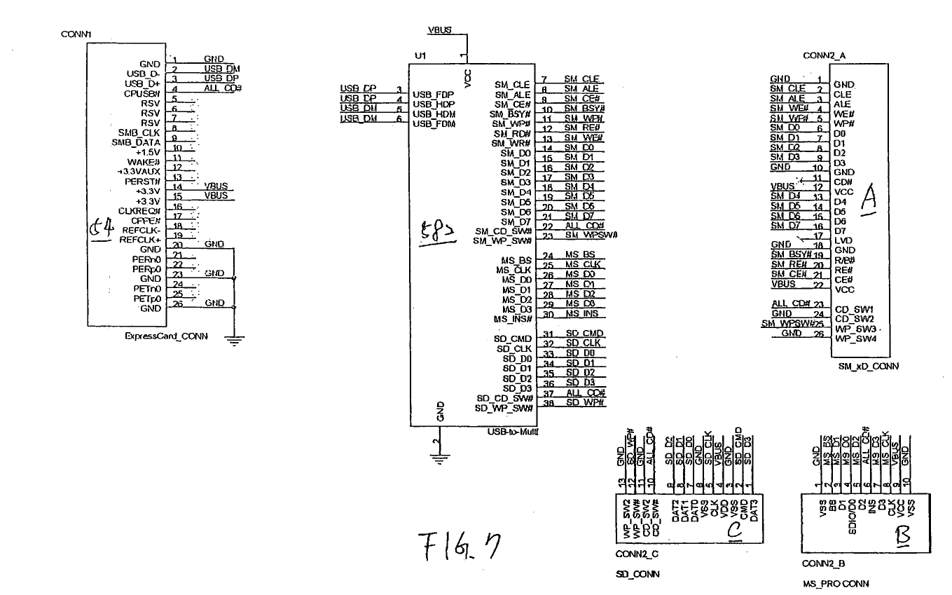

FIG. 7 is a schematic view of the pins layout of the interface embedded in the adapter shown in FIG. 5. The receivable memory cards can include three types, i.e. SM/xD standard, SD/MMC standard, and MS-series (such as MS, MS_PRO, MS_DUO) standard. Accordingly, the transmission interface of the signal converter 56 can be respectively divided into a transmission interface (A) compatible with SM/xD standard, a transmission interface (B) compatible with MS series, and a transmission interface (C) compatible with SD/MMC standard. The transmission interfaces (A), (B), (C) have data transmission pins and control pins respectively corresponding to each type of memory card. The multi-card reader control chip 582 and the signal converter 56 are connected each other in parallel and have corresponding connection pins defined as follows.

A PCI Express interface or a USB interface can be implemented with the adapter of the invention. In this embodiment, the double-configuration connector interface is a USB interface, and the multi-card reader control chip 582 is configured to convert the parallel transmission signals from the memory cards into USB serial signals.

Similar to the foregoing description, the multi-card reader control chip 582 has two sets of system data transmission pins, i.e. USB_HDP(4), USB_HDM(5) and USB_FDP(3), USB_FDM(6) pins respectively needed for high-speed USB (transmission rate of about 480 Mbps) and full-speed USB (transmission rate of about 12 Mbps). The double-configuration connector interface 54 has a set of differential serial pins 2, 3 connected to the system data transmission pins (i.e. USB_D− is connected to USB_HDM(5), USB_FDM(6), and USB_D+ is connected to USB_HDP(4), USB_FDP(3)). Via this connection scheme, signal transmission including address signals, data signals and control signals is performed with the external system.

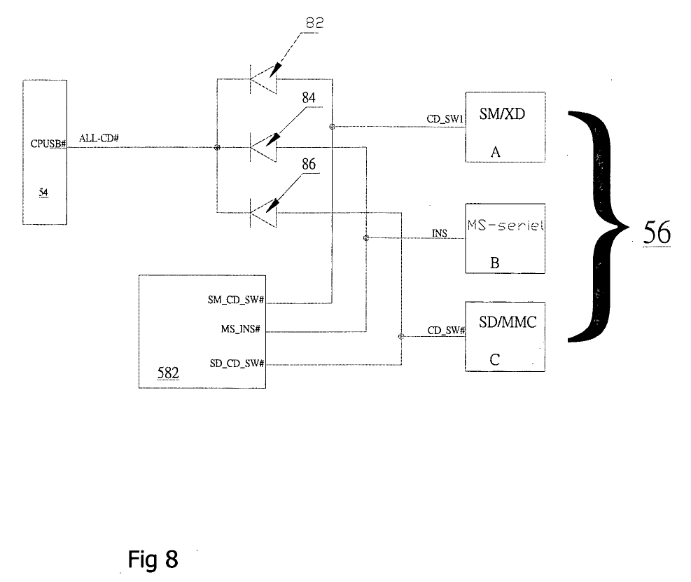

Referring to FIG. 7-8, the double-configuration connector interface 54 has a card insertion detect pin 4 (CPUSB#) for detecting the connection of a memory card. The signal converter 56 has a card detect pin 23 (CD_SW1) corresponding to a first type of memory card (for example SM/xD), a second card detect pin 6 (INS) corresponding to a second type of memory card (for example MS), and a third card detect pin 10 (CD_SW#) corresponding to a third type of memory card (for example SD/MMC). The multi-card reader control chip 582 has a first detect pin 22 (SM_CD_SW#), a second detect pin 30 (MS_INS#) and a third detect pin 37 (SD_CD_SW#), through which the multi-card reader control chip 582 detects the connection of memory card.

The first card detect pin 23 (CD_SW1) and the first detect pin 22 (SM_CD_SW#) are respectively connected via a passive element (such as a diode 82) to the card insertion detect pin 4 (CPUSB#). The second card detect pin 6 (INS) and the second detect pin 30 (MS_INS#) are respectively connected via a passive element (such as diode 84) to the card insertion detect pin 4 (CPUSB#). The third card detect pin 10 (CD_SW#) and the third detect pin 37 (SD_CD_SW#) are respectively connected via a passive element (such as diode 86) to the card insertion detect pin 4 (CPUSB#).

The double-configuration interface 14 further includes power terminals 14, 15. When the card insertion detect pin 4 (CPUSB#) is in an enabled status, the system end transmits an operating voltage to the adapter so that its internal electronic components can start the data reading needed by the system.

Those skilled in the art will readily understand that the above description is only illustrative of specific embodiments and examples of the invention, which should not be construed in a limiting way. Therefore, the invention should cover various modifications and variations made to the structure and operations described herein, provided they fall within the scope of the invention as defined in the following appended claims.

1. An Express Card interface adapter suitable for a small storage medium, comprising a casing configured to comply with the Express Card standard, wherein the small storage medium is a Compact Flash (CF) standard storage medium, the Express Card interface adapter being characterized in that:
a front end of the casing includes a double-configuration interface coupled with a system;
a rear end of the casing includes a U-shaped slot, wherein two sides of the U-shaped slot form guide tracks, a third side of the U-shaped slot has a CF standard interface, thereby the CF standard storage medium is placed in position by insertion along the guide tracks to connect to the CF standard interface;
a circuit board coupled between the double-configuration interface and the CF standard interface;
an IDE converter control chip connected on the circuit board and respectively coupled with the double-configuration interface and the CF standard interface, wherein the IDE converter control chip operates a signal controller between the CF standard storage medium and an external system;
wherein the CF standard interface at least includes a CF card detect pin;
wherein the IDE converter control chip at least has a set of system data transmission pins; and
wherein the double-configuration interface includes:
a card insertion detect pin coupled with the CF card detect pin to determine whether the CF standard storage medium is inserted;
a set of differential serial pins coupled with the system data transmission pins to conduct signal transmission with the external system.

2. The Express Card interface adapter of claim 1, wherein the CF standard storage medium includes a removable CF memory card and a micro drive.

3. The Express Card interface adapter of claim 1, wherein the CF standard storage medium includes a fixed small hard disk.

4. The Express Card interface adapter of claim 1, wherein the double-configuration interface includes a PCI Express interface and a USB interface.

5. The Express Card interface adapter of claim 4, wherein the PCI Express interface is used as an operating interface.

6. The Express Card interface adapter of claim 4, wherein the USB interface is used as an operating interface.

7. The Express Card interface adapter of claim 1, wherein the double-configuration interface includes a power terminal that transmits an operating voltage issued from the system under an enable status of the card insertion detect pin.

8. The Express Card interface adapter of claim 1, wherein the CF standard interface further includes a plurality of address pins, data transmission pins and control pins.

9. The Express Card interface adapter of claim 1, wherein the IDE converter control chip includes a plurality of address pins, data transmission pins and control pins respectively corresponding to those of the CF standard interface.

10. An Express Card interface adapter suitable for a small storage medium, comprising a casing configured to comply with the Express Card standard, the interface adapter being characterized in that:
a front end of the casing includes a double-configuration interface coupled with a system;
a rear end of the casing forms a slot to accommodate the insertion of a small memory card;
an inside of the casing corresponding to the slot includes a signal converter configured to accommodate the small memory card and conduct signal transmission via the double-configuration interface to the system;
a circuit board coupled between the double-configuration interface and the signal converter;
a multi-card reader control chip assembled on the circuit board and respectively coupled with the double-configuration interface and the signal converter, wherein the multi-reader control chip operates as a signal controller between the system and the small memory card;
wherein the double-configuration interface at least includes:
a set of differential serial pins configured to conduct signal transmission with the system; and
a card insertion pin configured to determine whether the memory card is inserted;
wherein the multi-card reader control chip includes:
a set of system data transmission pins coupled with the differential serial pins; and
a first detect pin, a second detect pin, a third detect pin respectively for detecting the insertion of the memory card;
wherein the signal converter includes:
a first type card detect pin coupled with the card insertion detect pin and the first detect pin, wherein the first type card detect pin detects the insertion of a first type of memory card;
a second type card detect pin coupled with the card insertion detect pin and the second detect pin, wherein the second type card detect pin detects the insertion of a second type of memory card;
a third type card detect pin coupled with the card insertion detect pin and the third detect pin, wherein the third type card detect pin detects the insertion of a third type of memory card.

11. The Express Card interface adapter of claim 10, the first type of memory card includes a SM or xD small memory card.

12. The Express Card interface adapter of claim 10, wherein the second type of memory card includes a MS small memory card.

13. The Express Card interface adapter of claim 10, wherein the third type of memory card includes a SD or MMC small memory card.

14. The Express Card interface adapter of claim 10 wherein the double-configuration interface further includes a PCI Express interface and a USB interface.

15. The Express Card interface adapter of claim 14, wherein the PCI Express interface is used as an operating interface.

16. The Express Card interface adapter of claim 14, wherein the USB interface is used as an operating interface.

17. The Express Card interface adapter of claim 10, wherein the double-configuration interface includes a power terminal that transmits an operating voltage issued from the system under an enable status of the card insertion detect pin.

18. The Express Card interface adapter of claim 10, wherein the signal converter includes three sets of system data transmission pins and control pins respectively corresponding to the three types of memory card.

19. The Express Card interface adapter of claim 18, wherein the multi-card reader control chip includes a plurality of data transmission pins and control pins corresponding to the signal converter.
